(19) United States
(12) Patent Application Publication
(10) Pub. No.: US 2016/0347524 A1
(43) Pub. Date: Dec. 1, 2016

(54) SLIDE CARD WITH HINGED PANEL FOR ADDITIONAL PILL CAVITIES

(71) Applicant: WestRock MWV, LLC, Norcross, GA (US)

(72) Inventors: Marty JONES, Glen Allen, VA (US); James D. KNOTTS, Glen Allen, VA (US)

(21) Appl. No.: 15/156,519

(22) Filed: May 17, 2016

Related U.S. Application Data
(60) Provisional application No. 62/167,411, filed on May 28, 2015.

(51) Int. Cl. B65D 75/52; B65D 75/32; B65D 77/04; A61J 1/03

(52) U.S. Cl. CPC B65D 75/52; A61J 1/035; B65D 75/323; B65D 77/04; B65D 2575/3245

(57) ABSTRACT

The slide card includes a base panel, a locking panel, and an additional panel. The locking panel is integrally formed with the base panel. The base panel and the additional panel each include cavities for holding product items. The locking panel is hingedly connected directly to one of the end edges of the base panel along a hinge. The locking panel is folded about the hinge to take a folded position where the locking panel is disposed over the first portion of the base panel. The locking panel has at least one second embossment integrally formed therewith and projecting therefrom. The at least one the first embossment and the at least one second embossment are disposed next to each other with the hinge disposed therebetween.

### REFERENCE TO RELATED APPLICATION

This application claims the benefit of priority under 35 U.S.C. §119(e) of U.S. provisional application Ser. No. 62/167,411 filed on May 28, 2015, which is hereby incorporated by reference in its entirety.

### FIELD OF THE INVENTION

This invention relates to unit dose packaging systems, and more particularly to an improved slide card having blisters integrally formed therewith and elements for enhancing performance of a locking panel of the slide card.

### BACKGROUND OF THE INVENTION

Unit dose packaging systems are useful as a means for dispensing individual, or unit, dose of a medicament. Such systems are even more useful when they have the added features of providing resistance to the package being opened by a child while at the same time facilitating ease of opening, closing and general use by older individuals whose manual dexterity may have decreased with age. These two attributes are typically referred to as packages, or systems, that are “child-resistant” and “senior-friendly,” respectively.

The MeadWestvaco Corporation, or one of its predecessor entities, owns patents issued in the United States that disclose unit dose packaging systems that possess child-resistant and senior-friendly characteristics. MeadWestvaco Corporation, the owner of the present application, is the owner of U.S. Pat. No. 6,047,829, U.S. Pat. No. 6,230,893, U.S. Pat. No. 6,412,636 and U.S. Pat. No. 6,752,272, which disclose unit dose packaging systems. The specifications and teachings of those four patents are hereby incorporated by reference.

U.S. Pat. No. 6,047,829 discloses a unit dose packaging system having a slide card that is received within a shell. The insertable inner slide card is formed from side panels and side panel extensions, both of symmetric construction, that are folded over upon one another to form the slide card. One set of the symmetric side panels contain conventional unit dose packaging holes for receiving respective unit dose blisters. The symmetric equivalents of these panels contain perforated areas corresponding to the holes for permitting removal of respective unit doses. The side panel extensions are disposed at one end of and extend longitudinally from the side panel portions to form an extension to form a panel that will be a part of the systems locking arrangement. The extension is folded over onto the side panel portion to be in condition to engage two separate locking mechanisms. In both locking arrangements, the leading edge of the extension engages an edge and/or opening in the sleeve or shell in a manner that inhibits withdrawal of the slide card until desired. One locking mechanism is positioned at a posterior end of the sleeve/shell to maintain the insert in place fully inserted in the sleeve/shell. A release mechanism can be depressed to lower and disengage the extension, thereby allowing the insert to be withdrawn. A second locking mechanism is formed by folded panels disposed at the anterior end of the sleeve, which is the opening. The folded panel or panels provide a stopping mechanism upon which the extension catches to prevent the slide card from being completely withdrawn

U.S. Pat. No. 6,230,893 discloses an improvement in the sleeve/shell of a cut-out and node to facilitate use of a first locking mechanism that fully retains the slide card within the sleeve/shell.

U.S. Pat. No. 6,412,636 discloses a unit dose packaging system wherein the outer sleeve includes offset notches for grasping and removing an internal slide card and the outer sleeve is at least partially laminated with a polymeric film.

Preventing or inhibiting undesired partial or full removal of the internal slide card from the sleeve/shell is important in helping facilitate resistance to child tampering and use by seniors. Thus, it will be appreciated that it is useful to have a unit dose package that enhances the operation of features that prevent or inhibit the undesired removal of the internal slide card from the sleeve/shell.

Because cost of manufacturing is an important factor in the production of any product, it will likewise be appreciated that it is desirable to have a unit dose package that is efficient to operate, is durable and sturdy, and simple to construct thereby reducing the cost of manufacture.

### SUMMARY

The present invention provides an inner slide card for selective insertion and withdrawal from a sleeve, the slide card including a base panel having at least a first blister, a locking panel connected to a first end edge of the base panel along a first hinge, an additional panel having at least a second blister; the additional panel connected to a second edge of the base panel along a second hinge, a lidding film adhered directly to the base panel and the additional panel and sealing the first and second blisters, wherein with the slide card in a flat configuration the lidding film forms a first outward surface and the base panel forms a second, opposed outward surface.

In certain embodiments the slide card consists essentially of a lidding film adhered to a series of panels formed from plastic. In certain embodiments the panels are thermoformed from plastic.

In certain embodiments the second edge of the base panel is opposite the first end edge of the base panel. In certain embodiments the second edge is a longitudinal edge of the base panel and is perpendicular to the first end edge of the base panel.

In certain embodiments the slide card further includes a spine panel between the base panel and the additional panel.

In certain embodiments the additional panel is folded along the second hinge and overlaps the base panel with the lidding film in facing relationship. In certain embodiments the additional panel is folded along the second line until the first and second blisters are in facing relationship. In certain embodiments the first and second blister are intercalated.

In certain embodiments the slide card is combined with an open-ended sleeve, wherein the slide card is received within the sleeve. In certain embodiments the locking panel is held with the sleeve by the locking panel contacting a lock feature within the sleeve. In certain embodiments the sleeve includes a release button which disengages the locking panel from the lock feature.

In certain embodiments the locking panel includes a stiffening feature. In certain embodiments the stiffening feature includes a first debossment. In certain embodiments the stiffening feature includes a first embossment.

In certain embodiments the first hinge is formed by a single weakened line. In certain embodiments the first hinge is formed by a groove line. In certain embodiments the first hinge is formed by a series of perforations.

### BRIEF DESCRIPTION OF THE DRAWINGS

FIG. 1A is a top plan view of a slide card in accordance with an embodiment of the invention.

FIG. 1B is a side cross section view of the slide card of FIG. 1A.

FIG. 1C is a side view of several elements of the slide card.

FIG. 2 is a perspective view of the slide card of FIG. 1 showing the locking panel partially pivoted with respect to the base panel.

FIG. 3A is a perspective view of the slide card of FIG. 1 with the additional panel partially pivoted upward with respect to the base panel towards a fully pivoted configuration wherein the slide card would be inserted within a sleeve or shell and the locking panel disposed for engagement by one or more locks of the sleeve/shell.

FIG. 3B is a side view of the slide card with the additional panel partially pivoted with respect to the base panel.

FIG. 3C is an end view of the slide card of FIG. 3B.

FIG. 3D is a side view of the slide card with the additional panel fully pivoted with respect to the base panel.

FIG. 3E is an end view of the slide card of FIG. 3D.

FIG. 4A is a perspective view of the slide card along with a sleeve for receiving the slide card.

FIG. 4B is a perspective view of the slide card partially received into the sleeve.

FIG. 4C is a sectional side view of the slide card partially received into the sleeve.

FIG. 5 is a top plan view of a slide card in accordance with another embodiment of the invention.

FIG. 6 is a perspective view of the slide card of FIG. 5 showing the locking panel partially pivoted with respect to the base panel.

FIG. 7A is a perspective view of the slide card of FIG. 5 with the additional panel partially pivoted downward with respect to the base panel towards a fully pivoted configuration wherein the slide card would be inserted within a sleeve or shell and the locking panel disposed for engagement by one or more locks of the sleeve/shell.

FIG. 7B is a side view of the slide card with the additional panel partially pivoted with respect to the base panel.

FIG. 7C is an end view of the slide card of FIG. 7B.

FIG. 7D is a side view of the slide card with the additional panel fully pivoted with respect to the base panel.

FIG. 7E is an end view of the slide card of FIG. 7D.

FIG. 8 is a top plan view of a slide card in accordance with another embodiment of the invention.

FIG. 9 is a perspective view of the slide card of FIG. 8 showing the locking panel partially pivoted with respect to the base panel.

FIG. 10A is a perspective view of the slide card of FIG. 8 with the additional panel partially pivoted downward with respect to the base panel towards a fully pivoted configuration wherein the slide card would be inserted within a sleeve or shell and the locking panel disposed for engagement by one or more locks of the sleeve/shell.

FIG. 10B is a side view of the slide card with the additional panel partially pivoted with respect to the base panel.

FIG. 10C is an end view of the slide card of FIG. 10B.

FIG. 10D is a side view of the slide card with the additional panel fully pivoted with respect to the base panel.

FIG. 10E is an end view of the slide card of FIG. 10D.

FIG. 11 is a top plan view of a slide card in accordance with another embodiment of the invention.

FIG. 12 is a perspective view of the slide card of FIG. 11 showing the locking panel partially pivoted with respect to the base panel.

FIG. 13A is a perspective view of the slide card of FIG. 11 with the additional panel partially pivoted downward with respect to the base panel towards a fully pivoted configuration wherein the slide card would be inserted within a sleeve or shell and the locking panel disposed for engagement by one or more locks of the sleeve/shell.

FIG. 13B is a side view of the slide card of FIG. 13A showing the additional panel partially pivoted with respect to the base panel.

FIG. 13C is an end view of the slide card of FIG. 13B.

FIG. 13D is a side view of the slide card with the additional panel fully pivoted with respect to the base panel.

FIG. 13E is an end view of the slide card of FIG. 13D.

FIG. 14A is a top plan view of a slide card in accordance with another embodiment of the invention.

FIG. 14B is a perspective view of the slide card of FIG. 14A showing the locking panel partially pivoted with respect to the base panel.

FIG. 14C is a perspective view of the slide card of FIG. 14A with the additional panel partially pivoted upward with respect to the base panel towards a fully pivoted configuration wherein the slide card would be inserted within a sleeve or shell and the locking panel disposed for engagement by one or more locks of the sleeve/shell.

FIG. 15A is a top plan view of a slide card in accordance with another embodiment of the invention.

FIG. 15B is a perspective view of the slide card of FIG. 15A showing the locking panel partially pivoted with respect to the base panel.

FIG. 15C is a perspective view of the slide card of FIG. 15A with the additional panel partially pivoted downward with respect to the base panel towards a fully pivoted configuration wherein the slide card would be inserted within a sleeve or shell and the locking panel disposed for engagement by one or more locks of the sleeve/shell.

FIGS. 16A-16E show cross sectional views of various types of hinge lines for connecting a locking panel or an additional panel to a base panel. FIG. 17 is a perspective view of a slide card in accordance with another embodiment of the invention.

### DETAILED DESCRIPTION OF THE INVENTION

As required, detailed embodiments of the present invention are disclosed herein. It must be understood that the disclosed embodiments are merely exemplary of the invention that may be embodied in various and alternative forms, and combinations thereof. The figures are not necessarily to scale and some features may be exaggerated or minimized to show details of particular components. In other instances, well-known components, systems, materials or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

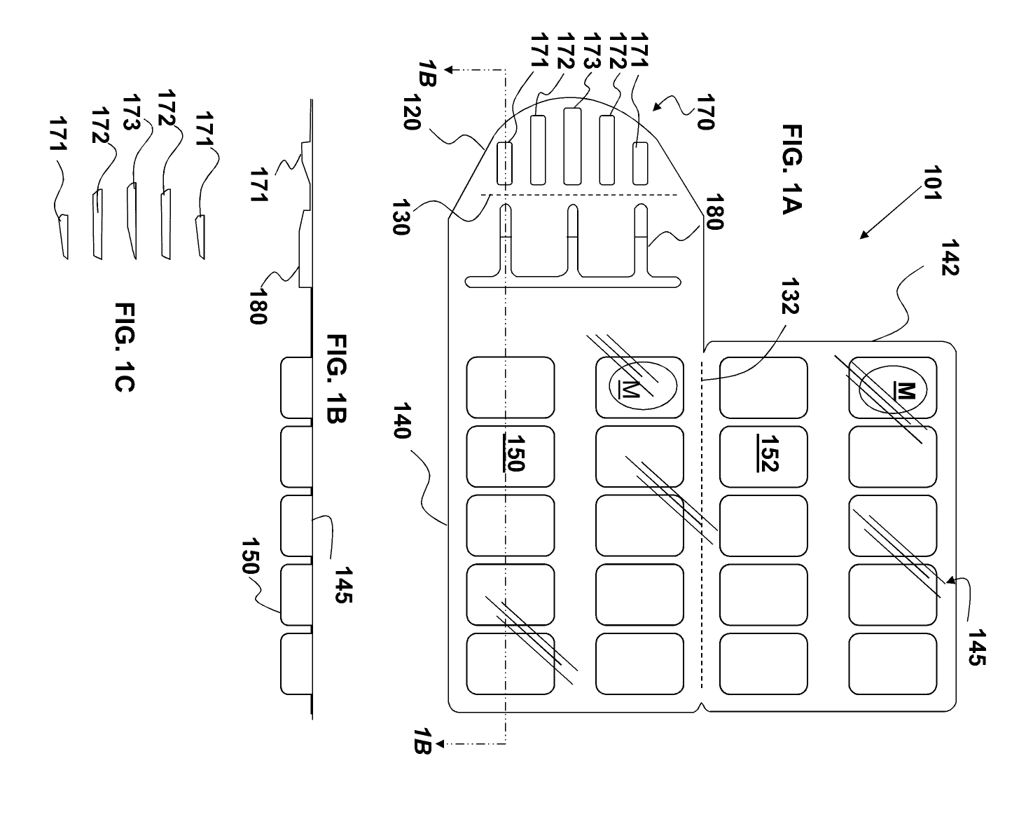

Referring first to FIG. 1A, there is illustrated a slide card 101 in accordance with a preferred embodiment of the invention. Slide card 101 has a base panel 140 and a locking panel 120 connected by a first hinge 130. The base panel has blisters 150 for holding a medicament M. For simplicity only a few medicaments are shown in the Figures, but it will be understood that each blister 150 may at least initially contain a medicament. The base panel 140 has one or more fold-resisting abutments 180 formed therein, and the locking panel 120 has one or more fold-resisting abutments (generally denoted as 170) formed therein, in each case the abutments formed proximate the first hinge 130. For simplicity with the drawings, the abutments 170, 180 are not shown on all the Figures.

Additional panel 142 is connected to base panel 140 through a second hinge 132. Additional panel 142 has blisters 152 for holding a medicament M.

A lidding film 145 covers at least the portions of base panel 140 and additional panel 152 that have the blisters 150, 152. The lidding film 145 is shown here as a transparent material, but it will be understood that the lidding film 145 may be an opaque material such as a metal foil or a translucent material. The lidding film 145 is shown as one continuous piece of material, although more than one piece of material may be used, provided it covers any blister 150, 152 that contains a medicament M.

Blisters 150, 152 and abutments 170, 180 may be pressed downward (debossed) into the panels as illustrated in the Figures here. If this is done, the upper surface of the panels will be flat and will readily seal to the lidding film 145. If certain features (such as the abutments 170, 180) need not be sealed by the lidding film such features might also be also formed by embossing.

It should be noted that the slide card panels may be made entirely of a single blank of plastic material and one or more sheets of lidding film to cover the blisters. Thus when the slide card 101 is in a flat configuration with hinges 130, 132 not folded, the slide card 101 in its base panel 140 portion has a first or surface formed by lidding film 145, and an opposite or lower surface formed by the plastic of base panel 140. A paperboard layer or partial paperboard layer is not found on either the first or second surfaces.

FIG. 1B shows a side cross section view of the slide card, indicating the approximate shape of the blisters 150 and abutments 170, 180. The abutments may serve to stiffen the slide card, particularly the locking panel 120 and the end of the slide base panel 140 adjacent the locking panel. The ends of the abutments 180 proximate to fold line 130 may be tapered like ramps in order to fit against the ends of abutments 170 proximate to fold line 130 when the locking panel 120 is folded back along fold line 130 toward base panel 140. FIG. 1C shows example side views of the abutments 170 (individually identified as 171, 172, 173) that are formed in the locking panel 120. In particular, those abutments 171, 173 which contact the abutments 180 may be tapered to fit against abutments 180. The shape, depth, and taper angle of the abutments may be such to resist folding of the locking panel beyond a certain angle.

Suitable materials to form the base panel, locking panel, and additional panel may include polyvinyl chloride, polypropylene, bio-based plastics, triplex, and other plastics. Suitable materials for the lidding film may include aluminum, bio-based plastics, and other plastics. Suitable materials for the sleeve may include paperboard, laminated paperboard, plastics, and other sheet materials.

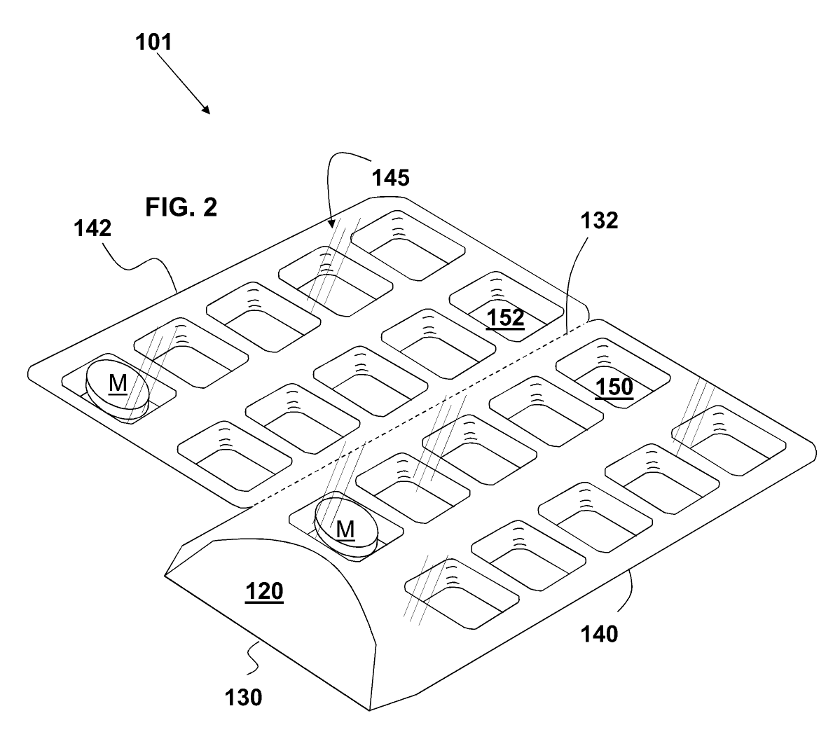

FIG. 2 shows a perspective view of the slide card 101 with the locking panel 120 folded upward along hinge 130 so that the locking panel 120 overlies part of base panel 140. For simplicity the abutments 170, 180 are not shown. In the perspective view it is more clearly evident that the blisters 150, 152 are depressions in the base panel 140 and additional panel 142.

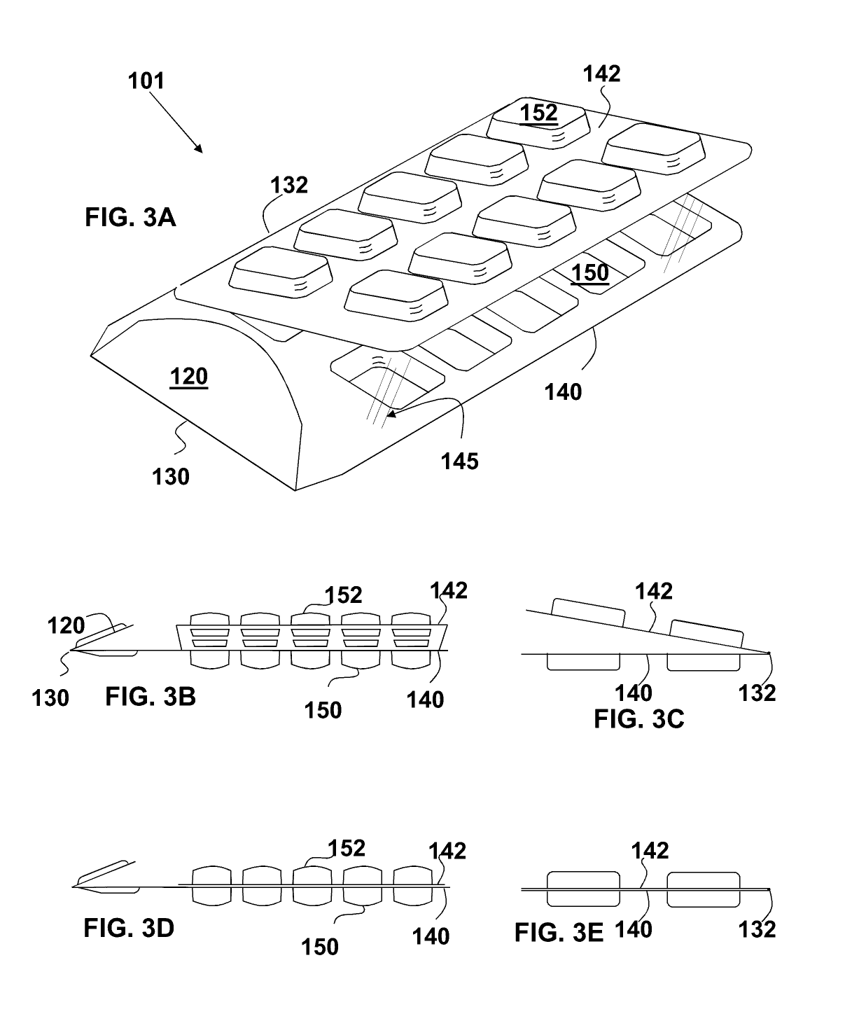

FIG. 3A shows a perspective view of slide card 101 with the additional panel 142 folded partway over along hinge 132 and approaching a face-to-face contact with the base panel 140, wherein the lidding film 145 on the base panel 140 will contact or face the lidding film 145 on additional panel 142.

FIG. 3B shows a side view of the slide card with the additional panel 142 folded partway over along hinge 132. FIG. 3C shows an end view from the end opposite the locking panel 120. The locking panel is omitted from the end view. FIG. 3D shows a side view with the additional panel 142 folded completely over onto the base panel 140. FIG. 3E shows the corresponding end view.

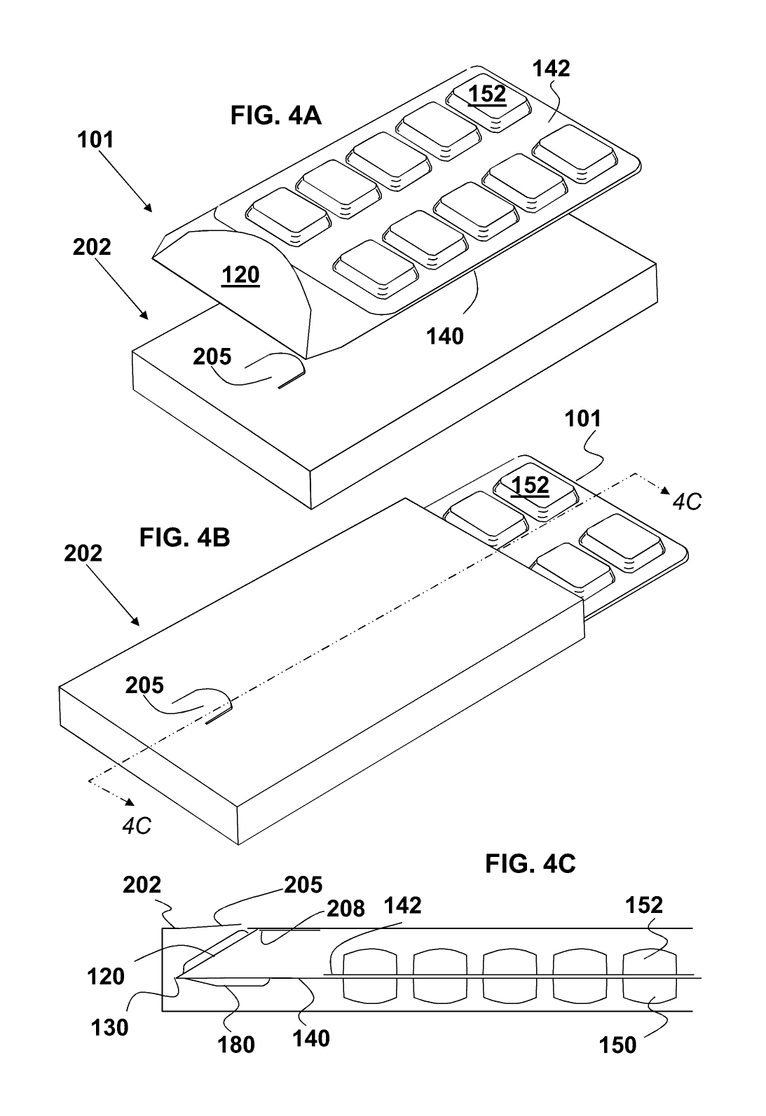

FIG. 4A shows a perspective view of slide card 101 along with a sleeve 202 for receiving the slide card. FIG. 4B shows a perspective view of slide card 101 partially received into sleeve 202. FIG. 4C shows a side view cross section of the structure with the slide card 101 fully received into sleeve 202. The locking panel 120 may be caught by an interior structure 208 within sleeve 202, such as an edge of an inner panel within the sleeve. An unlocking button 205 may be provided in sleeve 202, which may be depressed to flex the locking panel 120 away from the interior structure 208 in order that the slide card 101 may be pulled from sleeve 202.

Referring now to the side view of the slide card 101 in FIG. 4C, the alignment and relative disposition of fold-resisting abutments 170, 180 with respect to one another can be seen. Since abutments 170, 180 are generally perpendicular to the hinge 130, the abutments may help stiffness the base panel 140 and the locking panel 120 and enable a more secure locking action.

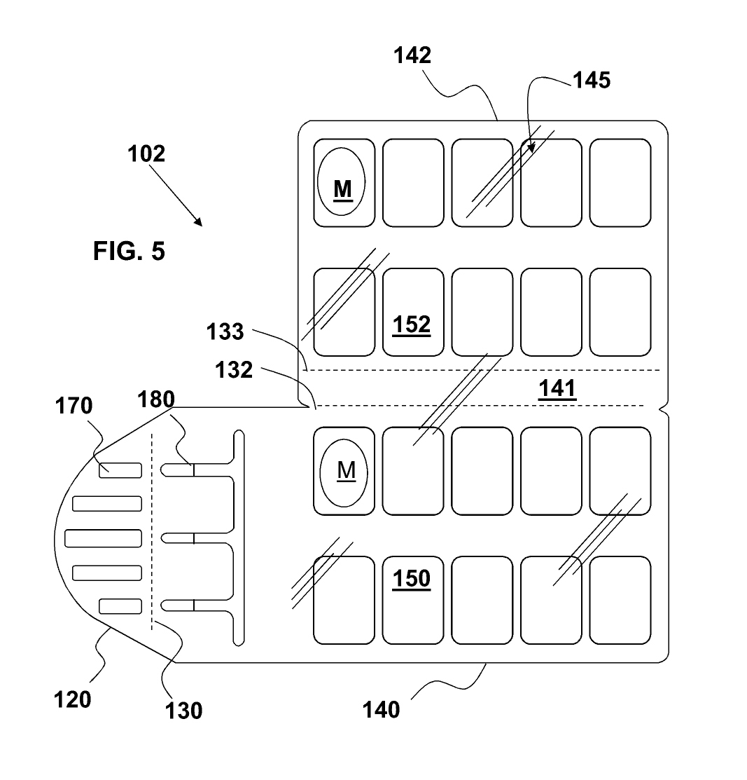

Referring now to FIG. 5, there is illustrated a slide card 102 in accordance with a preferred embodiment of the invention. Slide card 102 has a base panel 140 and a locking panel 120 connected by a first hinge 130. The base panel has blisters 150 for holding a medicament M. The base panel 140 has one or more fold-resisting abutments 180 formed therein, and the locking panel 120 has one or more fold-resisting abutments 170 formed therein, in each case the abutments formed proximate the first hinge 130.

Instead of additional panel 142 being connected to the base panel 140, with slide card 102, the base panel is first connected through hinge 132 to a spine panel 141, which in turn is connected through third hinge 133 to additional panel 142. Additional panel 142 has blisters 152 for holding a medicament M. A lidding film 145 covers at least the portions of base panel 140 and additional panel 142 that have the blisters 150, 152. The lidding film 145 is shown here as a transparent material, but it will be understood that the lidding film 145 may be an opaque material such as a metal foil or a translucent material. The lidding film 145 is shown as one continuous piece of material that covers the base panel 140, spine panel 141, and additional panel 142, although more than one piece of material may be used, provided it covers any blister 150, 152 that contains a medicament M.

Blisters 150, 152 and abutments 170, 180 may be pressed downward (debossed) into the panels as illustrated in the Figures here. If this is done, the upper surface of the panels will be flat and will readily seal to the lidding film 145. However, certain features such as the abutments 170, 180 need not be sealed by the lidding film and therefor the abutments 170, 180 may be also formed by embossing.

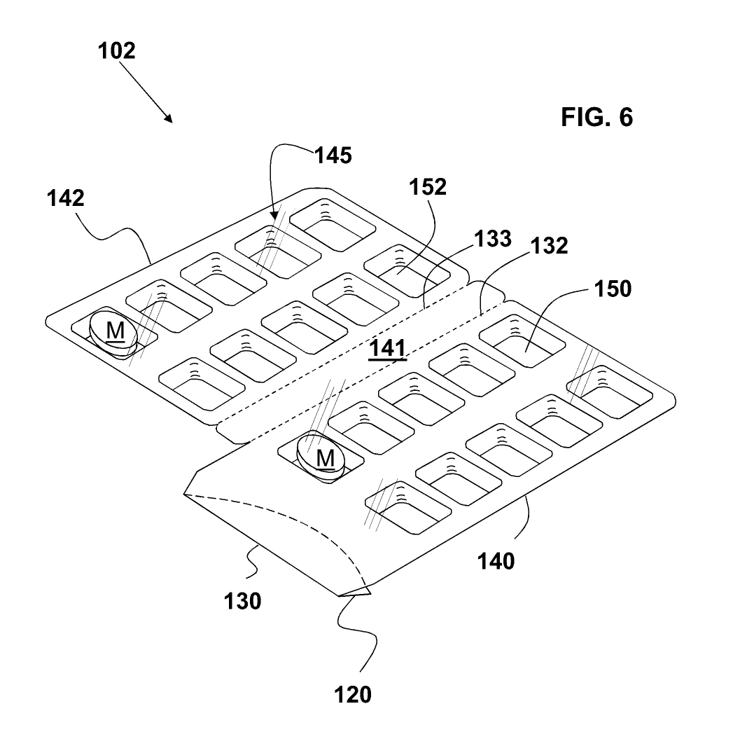

FIG. 6 shows a perspective view of the slide card 101 with the locking panel 120 folded downward along hinge 130 so that the locking panel 120 underlies part of base panel 140. Having the locking panel folded downward as shown may provide better engagement of the slide card 102 with the interior structure 208 within sleeve 202. (The slide card 102 may be inverted so that the locking panel 120 will engage the interior structure 208. For simplicity the abutments 170, 180 are not shown. In the perspective view it is more clearly evident that the blisters 150, 152 are depressions in the base panel 140 and additional panel 142.

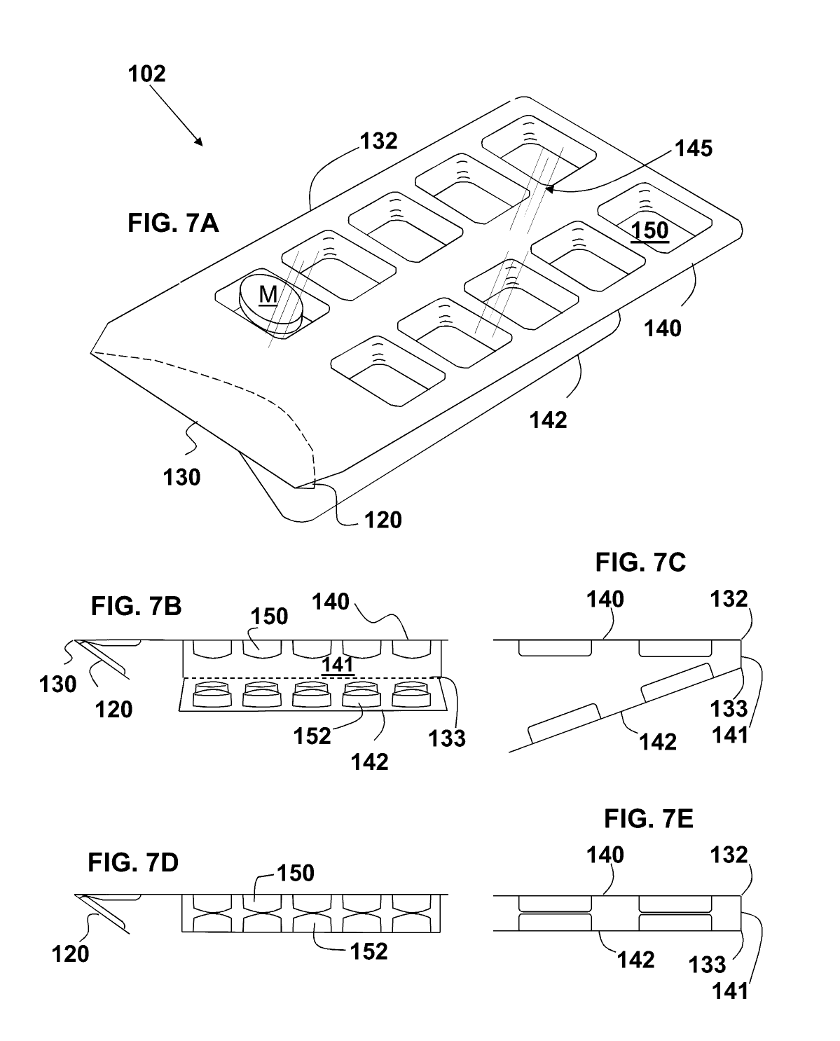

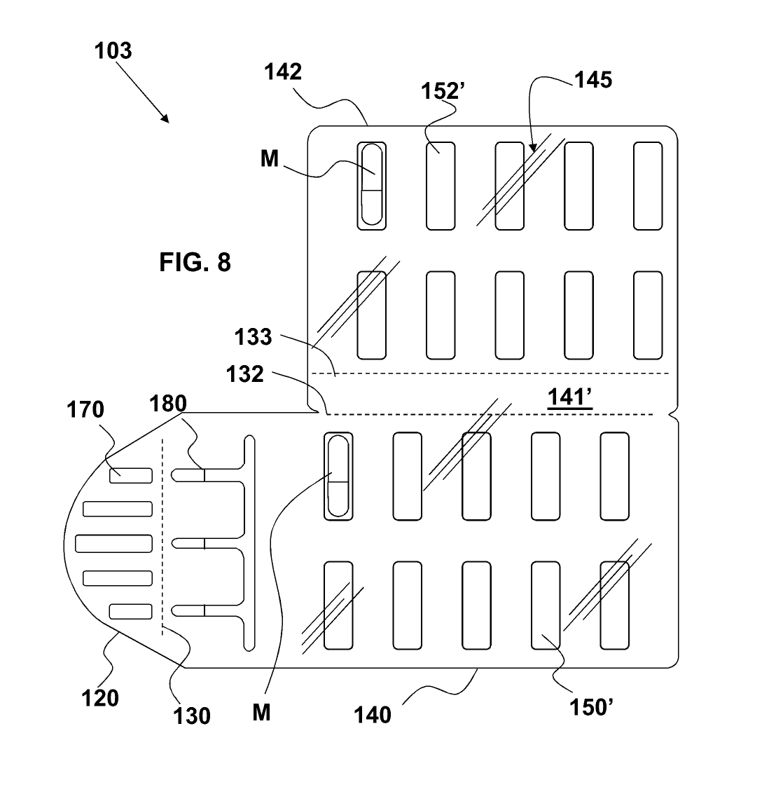

FIG. 7A shows a perspective view of slide card 102 with the additional panel 142 and spine panel 141 folded partway under base panel 140 along hinge 132, 133 and approaching a face-to-face orientation with the base panel 140, wherein the lidding film 145 on the base panel 140 will face the lidding film 145 on additional panel 142.

FIG. 7B shows a side view of the slide card 102 with the spine panel 141 and additional panel 142 folded partway under along hinges 132, 133. FIG. 7C shows an end view from the end opposite the locking panel 120. The locking panel is omitted from the end view. FIG. 7D shows a side view with the additional panel 142 folded completely under base panel 140. FIG. 7E shows the corresponding end view.

As shown, in this configuration the blisters 150, 152 may contact each other. Therefor the overall height or thickness of the slide card 102 may be approximately the combined height of blisters 150, 152. Also the overall height or thickness of the slide card 102 may be the height of spine panel 141.

As seen in FIGS. 7B and 7D, abutments 170, 180 may contact one another in this configuration and may tend to push the locking panel 120 outward relative to the base panel 140. This may help provide a good locking action.

Referring now to FIG. 8, there is illustrated a slide card 103 in accordance with a preferred embodiment of the invention. Slide card 103 is in many aspects similar to slide card 102, excepting for the blisters 150′, 152′.

Slide card 103 has a base panel 140 and a locking panel 120 connected by a first hinge 130. Base panel has blisters 150′ for holding a medicament M. The base panel 140 has one or more fold-resisting abutments 180 formed therein, and the locking panel 120 has one or more fold-resisting abutments 170 formed therein, in each case the abutments formed proximate the first hinge 130.

Base panel is connected through hinge 132 to a spine panel 141′, which in turn is connected through third hinge 133 to additional panel 142. Additional panel 142 has blisters 152′ for holding a medicament M. A lidding film 145 covers at least the portions of base panel 140 and additional panel 142 that have the blisters 150′, 152′. The lidding film 145 is shown here as a transparent material, but it will be understood that the lidding film 145 may be an opaque material such as a metal foil or a translucent material. The lidding film 145 is shown as one continuous piece of material that covers the base panel 140, spine panel 141′, and additional panel 142, although more than one piece of material may be used, provided it covers any blister 150′, 152′ that contains a medicament M.

Blisters 150′, 152′ and abutments 170, 180 may be pressed downward (debossed) into the panels as illustrated in the Figures here. If this is done, the upper surface of the panels will be flat and will readily seal to the lidding film 145. However, certain features such as the abutments 170, 180 need not be sealed by the lidding film and therefor such features may be also formed by embossing.

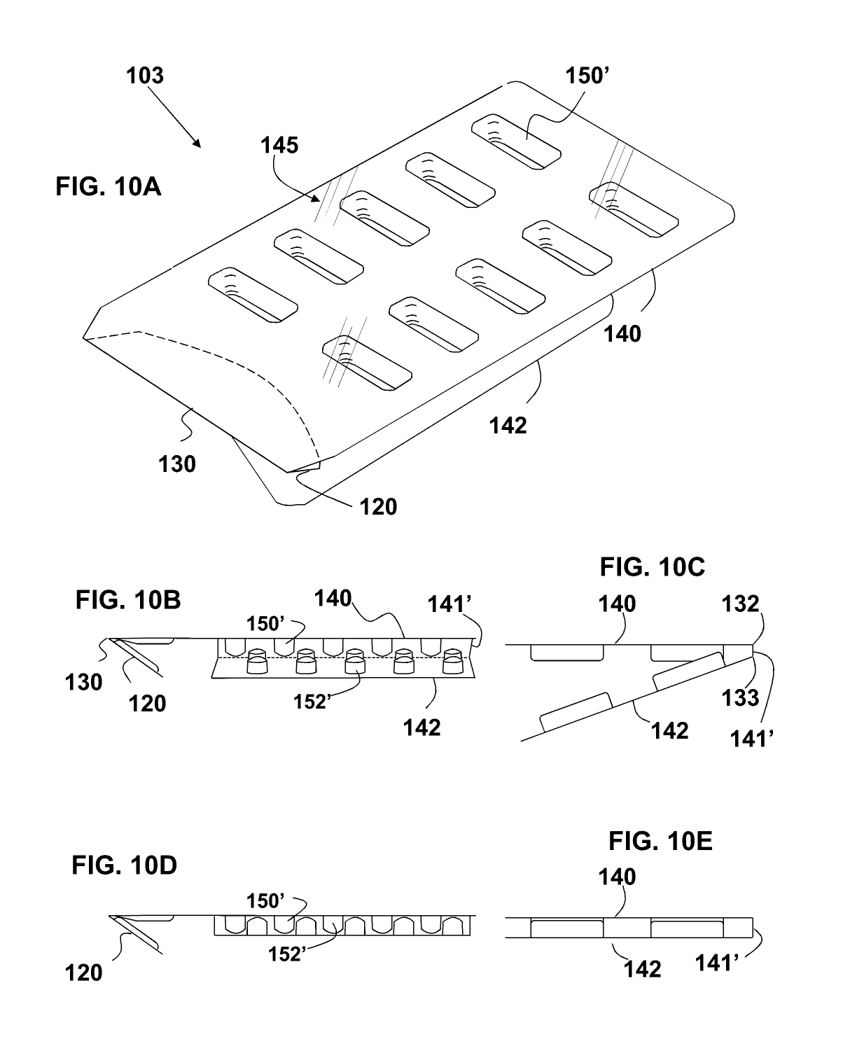

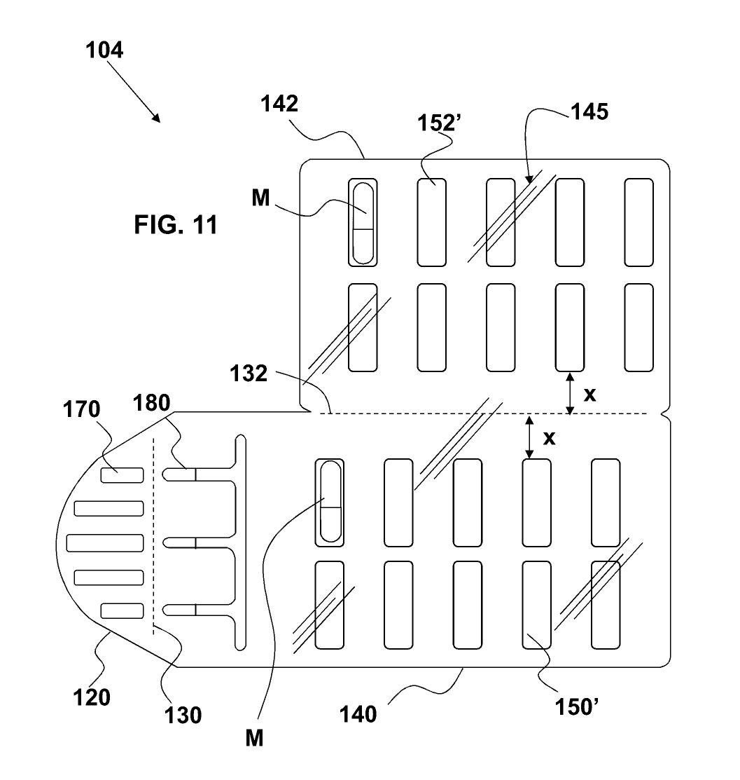

Blisters 150′, 152′ may be sized, positioned, or shaped so as to intercalate when the slide card is folded as shown in FIGS. 10B, 10C. For example, the blisters may be narrower, there may be additional space between adjacent blisters, and the blisters 152′ on additional panel 142 may be shifted relative to the blisters 150′ on the base panel 140.

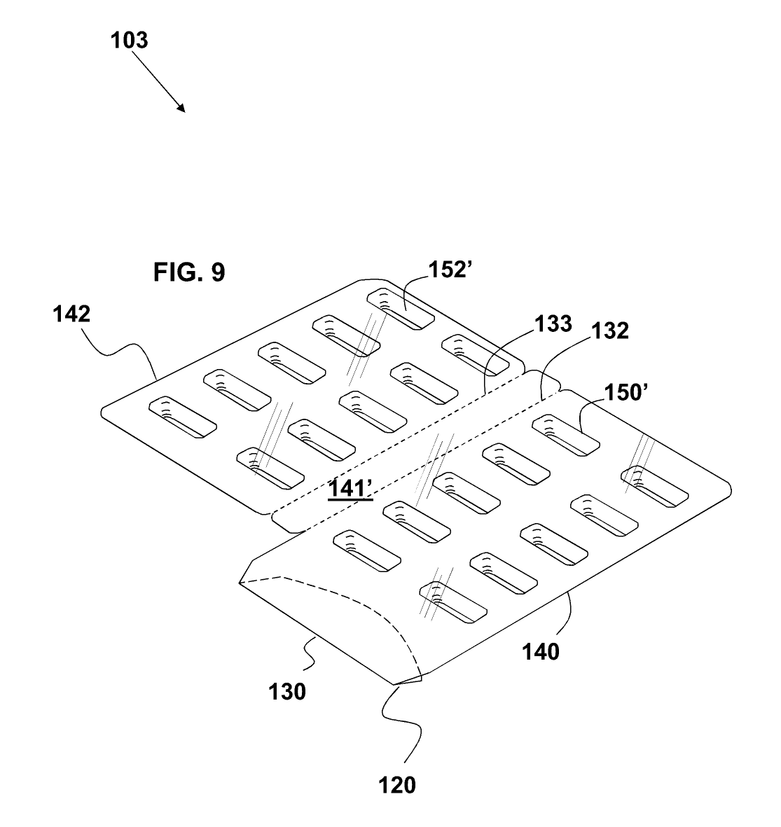

FIG. 9 shows a perspective view of the slide card 102 with the locking panel 120 folded downward along hinge 130 so that the locking panel 120 underlies part of base panel 140. Having the locking panel folded downward as shown may provide better engagement of the slide card 102 with the interior structure 208 within sleeve 202. (The slide card 103 may be inverted so that the locking panel 120 will engage the interior structure 208. For simplicity the abutments 170, 180 are not shown. In the perspective view it is more clearly evident that the blisters 150, 152 are depressions in the base panel 140 and additional panel 142.

FIG. 10A shows a perspective view of slide card 103 with the additional panel 142 and spine panel 141 folded partway under base panel 140 along hinge 132, 133 and approaching a face-to-face orientation with the base panel 140, wherein the lidding film 145 on the base panel 140 will face the lidding film 145 on additional panel 142.

FIG. 10B shows a side view of the slide card 103 with the spine panel 141′ and additional panel 142 folded partway under along hinges 132, 133. FIG. 10C shows an end view from the end opposite the locking panel 120. The locking panel is omitted from the end view. FIG. 10D shows a side view with the additional panel 142 folded completely under base panel 140. FIG. 10E shows the corresponding end view.

As shown, in this configuration the blisters 150′, 152′ may intercalate, that is fit between, each other. Therefor the overall height or thickness of the slide card 103 may be approximately the height of blisters 150′, 152′. Also the overall height or thickness of the slide card 103 may be the height of spine panel 141′.

As seen in FIGS. 10B and 10D, abutments 170, 180 may contact one another in this configuration and may tend to push the locking panel 120 outward relative to the base panel 140. This may help provide a good locking action.

Referring now to FIG. 11, there is illustrated a slide card 104 in accordance with a preferred embodiment of the invention. Slide card 104 is in many aspects similar to slide card 103, excepting for the placement of blisters 150′, 152′. It will be noted that the blisters 150′, 152′ are positioned away from hinge 132 by at least a distance x.

Slide card 104 has a base panel 140 and a locking panel 120 connected by a first hinge 130. Base panel 140 has blisters 150′ for holding a medicament M. The base panel 140 has one or more fold-resisting abutments 180 formed therein, and the locking panel 120 has one or more fold-resisting abutments 170 formed therein, in each case the abutments formed proximate the first hinge 130.

Base panel is connected through hinge 132 to additional panel 142. Additional panel 142 has blisters 152′ for holding a medicament M. A lidding film 145 covers at least the portions of base panel 140 and additional panel 142 that have the blisters 150′, 152′. The lidding film 145 is shown here as a transparent material, but it will be understood that the lidding film 145 may be an opaque material such as a metal foil or a translucent material. The lidding film 145 is shown as one continuous piece of material that covers the base panel 140 and additional panel 142, although more than one piece of material may be used, provided it covers any blister 150′, 152′ that contains a medicament M.

Blisters 150′, 152′ and abutments 170, 180 may be pressed downward (debossed) into the panels as illustrated in the Figures here. If this is done, the upper surface of the panels will be flat and will readily seal to the lidding film 145. However, certain features (such as the abutments 170, 180 need not be sealed by the lidding film and therefor the abutments 170, 180 may be also formed by embossing.

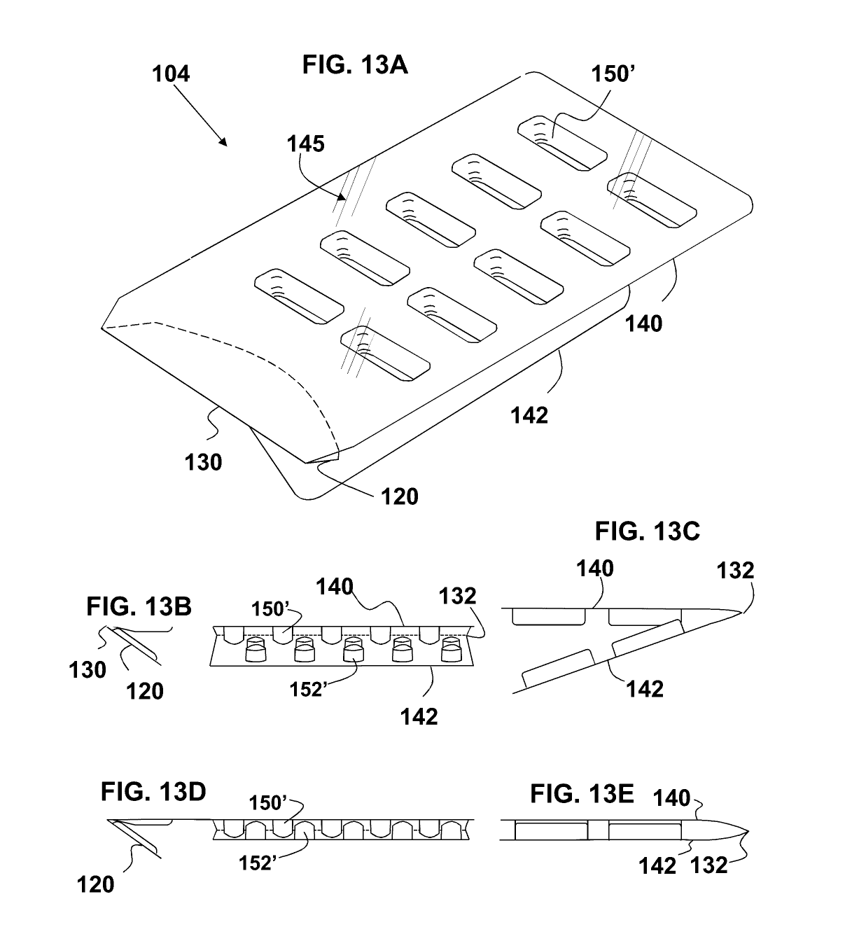

Blisters 150′, 152′ may be sized, positioned, or shaped so as to intercalate when the slide card is folded as shown in FIGS. 13B-13E. For example, the blisters may be narrower, there may be additional space between adjacent blisters, and the blisters 152′ on additional panel 142 may be shifted relative to the blisters 150′ on the base panel 140.

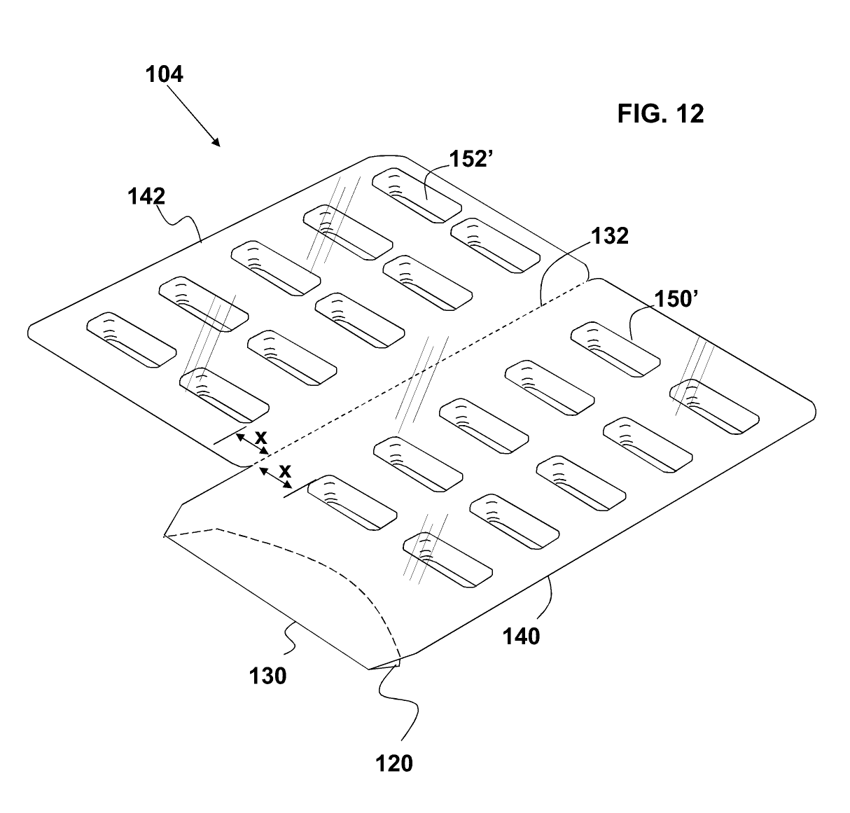

FIG. 12 shows a perspective view of the slide card 104 with the locking panel 120 folded downward along hinge 130 so that the locking panel 120 underlies part of base panel 140. Having the locking panel folded downward as shown may provide better engagement of the slide card 104 with the interior structure 208 within sleeve 202. (The slide card 104 may be inverted so that the locking panel 120 will engage the interior structure 208. For simplicity the abutments 170, 180 are not shown. In the perspective view it is more clearly evident that the blisters 150, 152 are depressions in the base panel 140 and additional panel 142.

FIG. 13A shows a perspective view of slide card 104 with the additional panel 142 folded partway under base panel 140 along hinge 132 and approaching a face-to-face orientation with the base panel 140, wherein the lidding film 145 on the base panel 140 will face the lidding film 145 on additional panel 142.

FIG. 13B shows a side view of the slide card 104 with the additional panel 142 folded partway under along hinge 132. FIG. 13C shows an end view from the end opposite the locking panel 120. The locking panel is omitted from the end view. FIG. 13D shows a side view with the additional panel 142 folded completely under base panel 140. FIG. 13E shows the corresponding end view.

As shown, in this configuration the blisters 150′, 152′ may intercalate, that is fit between, each other. Therefor the overall height or thickness of the slide card 104 may be approximately the height of blisters 150′, 152′. Although slide card 104 lacks a spine panel, blisters 150′, 152′ may be located a sufficient distance X away from hinge 132 so that the sufficient distance X allows some flexing of the base panel 140 and additional panel 142 adjacent hinge 132.

As seen in FIGS. 13B and 13D, abutments 170, 180 may contact one another in this configuration and may tend to push the locking panel 120 outward relative to the base panel 140. This may help provide a good locking action.

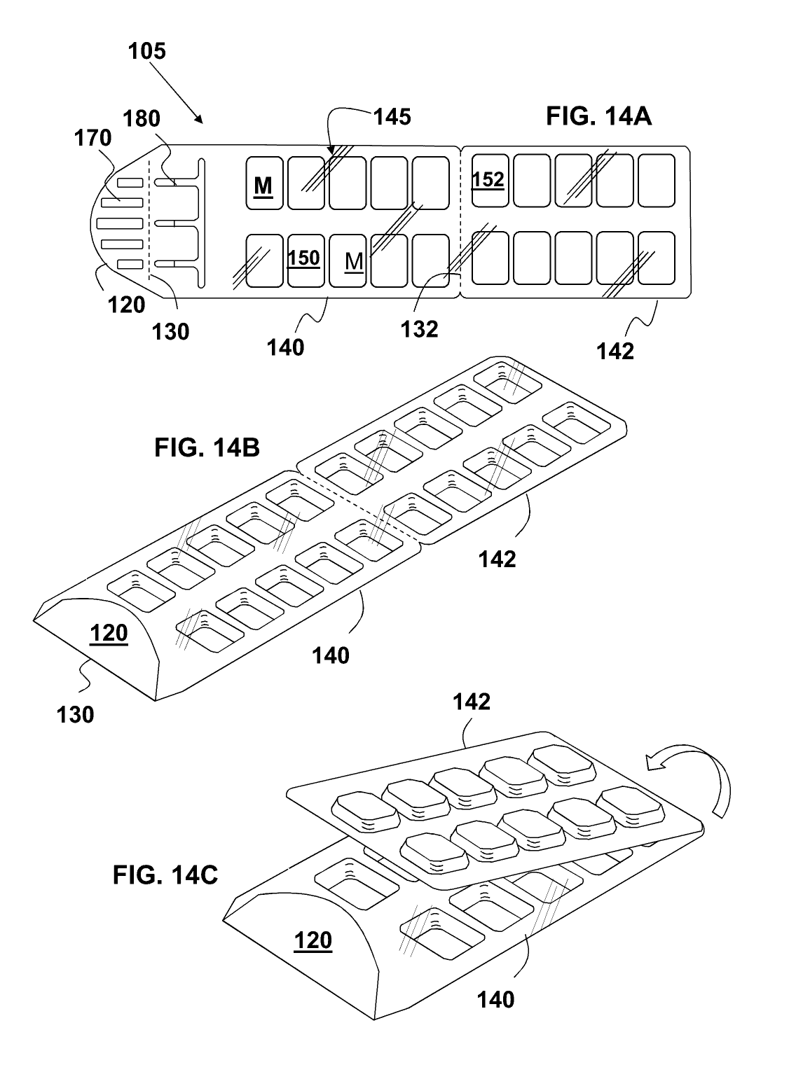

Referring now to FIG. 14A, there is illustrated a slide card 105 in accordance with a preferred embodiment of the invention. Slide card 105 is in many aspects similar to the earlier shown slide cards, excepting for the placement of the additional panel 142 extending off an end of the slide card (e.g. opposite end from the locking panel 120).

Slide card 105 has a base panel 140 and a locking panel 120 connected by a first hinge 130. Base panel 140 has blisters 150 for holding a medicament M. The base panel 140 has one or more fold-resisting abutments 180 formed therein, and the locking panel 120 has one or more fold-resisting abutments 170 formed therein, in each case the abutments formed proximate the first hinge 130.

Base panel is connected through hinge 132 to additional panel 142. Additional panel 142 has blisters 152 for holding a medicament M. A lidding film 145 covers at least the portions of base panel 140 and additional panel 142 that have the blisters 150, 152. The lidding film 145 is shown here as a transparent material, but it will be understood that the lidding film 145 may be an opaque material such as a metal foil or a translucent material. The lidding film 145 is shown as one continuous piece of material that covers the base panel 140 and additional panel 142, although more than one piece of material may be used, provided it covers any blister 150, 152 that contains a medicament M.

Blisters 150, 152 and abutments 170, 180 may be pressed downward (debossed) into the panels as illustrated in the Figures here. If this is done, the upper surface of the panels will be flat and will readily seal to the lidding film 145. However, certain features (such as the abutments 170, 180 need not be sealed by the lidding film and therefor the abutments 170, 180 may be also formed by embossing.

FIG. 14B shows a perspective view of the slide card 105 with the locking panel 120 folded upward along hinge 130 so that the locking panel 120 overlies part of base panel 140. Having the locking panel folded upward as shown may provide better engagement of the slide card 105 with the interior structure 208 within sleeve 202. For simplicity the abutments 170, 180 are not shown. In the perspective view it is more clearly evident that the blisters 150, 152 are depressions in the base panel 140 and additional panel 142.

FIG. 14C shows a perspective view of slide card 104 with the additional panel 142 folded partway over base panel 140 along hinge 132 and approaching a face-to-face orientation with the base panel 140, wherein the lidding film 145 on the base panel 140 will face the lidding film 145 on additional panel 142.

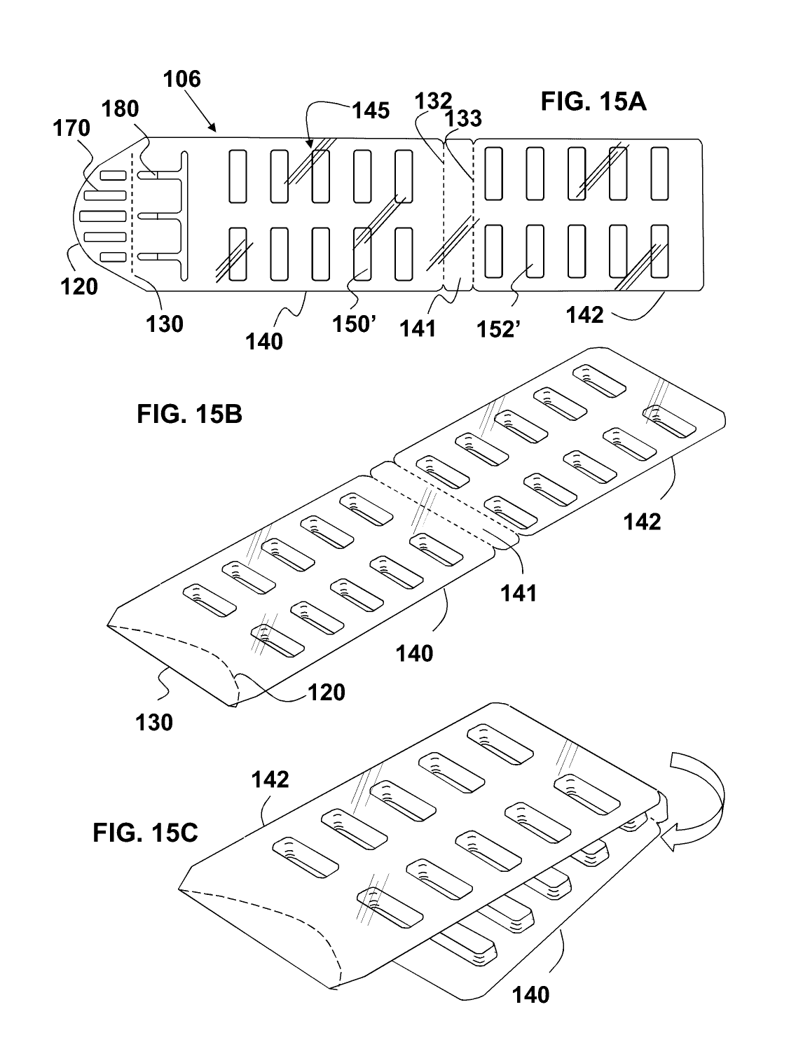

Referring now to FIG. 15A, there is illustrated a slide card 106 in accordance with a preferred embodiment of the invention. Slide card 106 is in many aspects similar to slide card 105, excepting for the placement of blisters 150′, 152′, and the use of a spine panel 141.

Slide card 106 has a base panel 140 and a locking panel 120 connected by a first hinge 130. Base panel has blisters 150′ for holding a medicament M. The base panel 140 has one or more fold-resisting abutments 180 formed therein, and the locking panel 120 has one or more fold-resisting abutments 170 formed therein, in each case the abutments formed proximate the first hinge 130.

Base panel is connected through hinge 132 to spine panel 141 which is then connected through hinge 133 to additional panel 142. Additional panel 142 has blisters 152′ for holding a medicament M. A lidding film 145 covers at least the portions of base panel 140 and additional panel 142 that have the blisters 150′, 152′. The lidding film 145 is shown here as a transparent material, but it will be understood that the lidding film 145 may be an opaque material such as a metal foil or a translucent material. The lidding film 145 is shown as one continuous piece of material that covers the base panel 140, spine panel 141, and additional panel 142, although more than one piece of material may be used, provided it covers any blister 150′, 152′ that contains a medicament M.

Blisters 150′, 152′ and abutments 170, 180 may be pressed downward (debossed) into the panels as illustrated in the Figures here. If this is done, the upper surface of the panels will be flat and will readily seal to the lidding film 145. However, certain features (such as the abutments 170, 180 need not be sealed by the lidding film and therefor the abutments 170, 180 may be also formed by embossing.

Blisters 150′, 152′ may be sized, positioned, or shaped so as to intercalate when the slide card is folded as shown in FIG. 15C. For example, the blisters may be narrower, there may be additional space between adjacent blisters, and the blisters 152′ on additional panel 142 may be shifted relative to the blisters 150′ on the base panel 140.

FIG. 15B shows a perspective view of the slide card 106 with the locking panel 120 folded downward along hinge 130 so that the locking panel 120 underlies part of base panel 140. Having the locking panel folded downward as shown may provide better engagement of the slide card 106 with the interior structure 208 within sleeve 202. (The slide card 106 may be inverted so that the locking panel 120 will engage the interior structure 208. For simplicity the abutments 170, 180 are not shown. In the perspective view it is more clearly evident that the blisters 150, 152 are depressions in the base panel 140 and additional panel 142.

FIG. 15C shows a perspective view of slide card 106 with the spine panel 141 and additional panel 142 folded partway under base panel 140 along hinges 132, 133 and approaching a face-to-face orientation with the base panel 140, wherein the blisters 150′ on the base panel 140 will intercalate, that is, fit between, the blisters 152′ on additional panel 142.

Thus, the overall height or thickness of the slide card 106 may be approximately the height of a blister 150′ or 152′, or of spine panel 141.

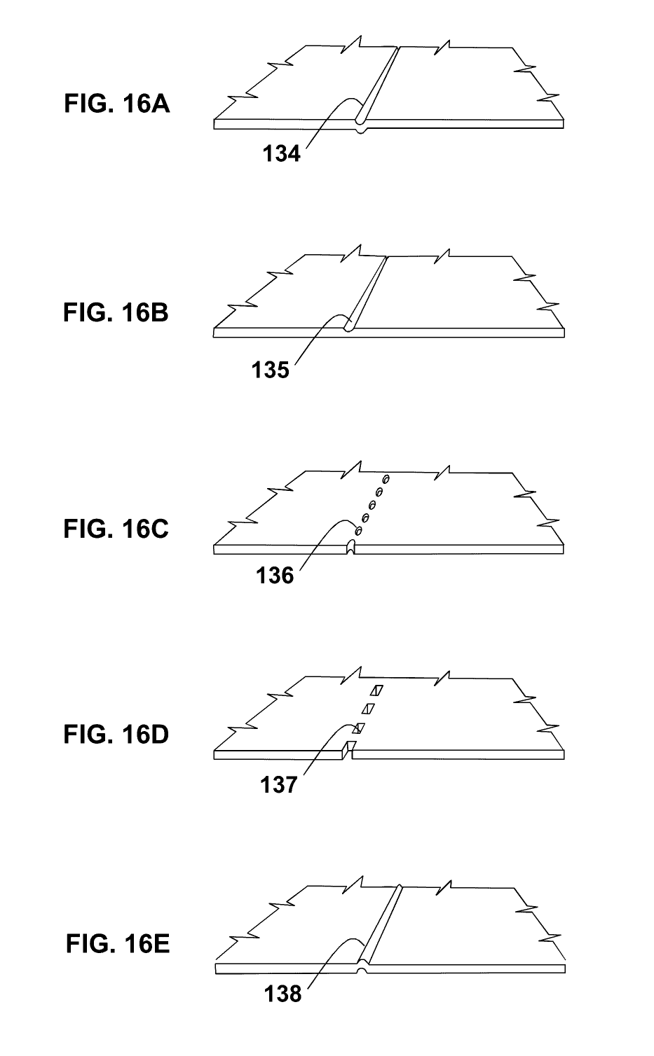

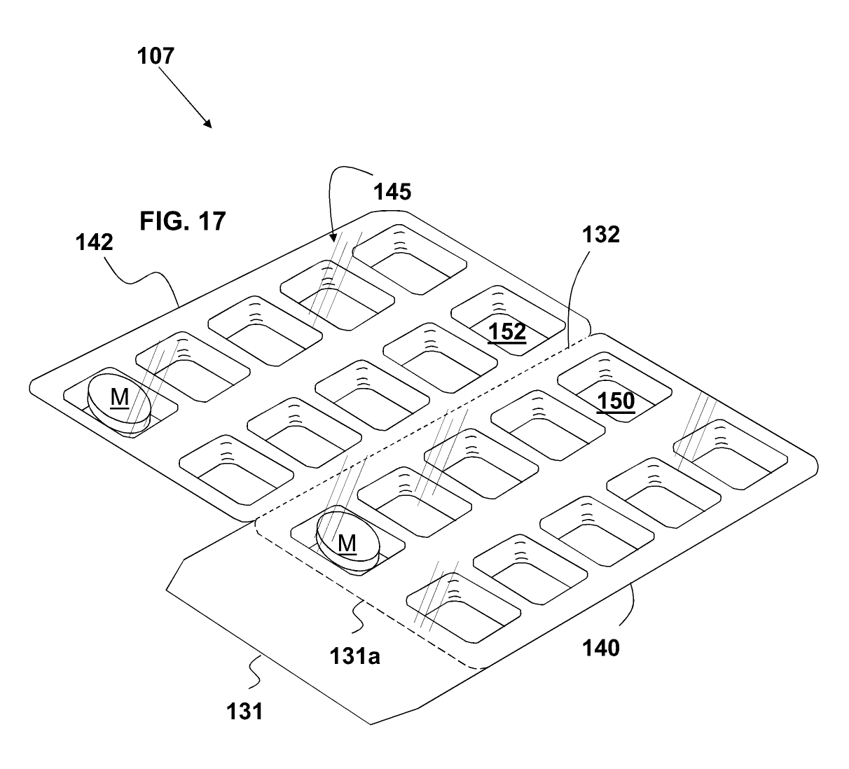

FIGS. 16A-16E show various types of hinges that may be used alone or in combination to form hinges 130, 132, 133.

FIG. 16A shows a formed hinge 134 that may be formed as a score or groove into or between the material of locking panel 120, base panel 140, and additional panel 142. The groove formed into the surface of the panel may coincide with a ridge on the opposite side of the material as shown in FIG. 16A, or the groove may exist without the opposite-side ridge, as shown by hinge 135 in FIG. 16B.

FIG. 16C shows a hinge 136 made up of a series of discontinuous holes into or through the panel material. FIG. 16D shows a hinge 137 made up of a series of discontinuous slots into or through the panel material.

Hinge 138 may be formed in the opposite direction from the other elements, namely, the fold-resisting abutments 170, 180, as shown in FIG. 16E. The hinge 138 as illustrated in FIG. 16E thus may be formed in an upward direction, opposite the direction in which the abutments 170, 180 are formed.

The flexibility of hinge types 134, 135, 136, 137, 138 may be controlled by adjusting the depth into or through the material, the width of the hinge area, or the relative proportions of the holes or slots compared with the undisturbed material along the hinge line.

The slide cards 101-106 may be made of plastic material and can be formed by manufacturing processes such as thermo-forming or die-press with a tool set. An integrated slide and blister panel as taught by the invention is simple and can be simply formed by these processes.

In another aspect of the invention, the ability of the locking panel 120 to be engaged by an aperture or panel that forms a part of the locking arrangement of the system's sleeve or shell is enhanced by biasing the locking panel away from a substantially parallel condition with respect to the base panel 140. A fold-resisting mechanism serves this purpose. The hinge 130 serves as a fold-resisting mechanism to bias the locking panel. The amount of bias in the hinge 130 may be controlled by manufacturing techniques such as varying the thickness of the hinge 130 or otherwise varying the degree to which a line forming the hinge 130 is weakened to permit bending. An abutment 170, 180 may serve as an additional or distinct fold-resisting mechanism or element. The abutment 170, 180 prevents the locking panel 120 and base panel 140 from being placed into a substantially parallel condition with respect to one another. Although one abutment 170, 180 on either of the locking panel 120 and the base panel 140 is sufficient to serve as a fold-resisting mechanism or element, more than one be used on either one or both panels. The use of opposing abutments 170, 180 on respective locking panel 120 and base panel 140, provides the advantage of being able to minimize the height of each abutment while still achieving desirable fold resistance. Although the abutment may take many forms, an embossed abutment may be easily manufactured in a substrate, particularly a slide card substrate of plastic.

In another aspect of the invention, the card may be used without a locking panel. An example of such a card 107 is shown in FIG. 17, which is similar to FIG. 2 but does not include a locking panel. If no locking panel is used, edge 131 may optionally be moved inward, for example to line 131a as denoted in FIG. 17.

Embodiments shown in other Figures herein may also be used with or without a locking panel.

In certain embodiments, the cards 101-107 may be used with or without a sleeve or shell.

It must be emphasized that the law does not require and it is economically prohibitive to illustrate and teach every possible embodiment of the present claims. Hence, the above-described embodiments are merely exemplary illustrations of implementations set forth for a clean understanding of the principles of the invention. Variations, modifications, and combinations may be made to the above-described embodiments without departing from the scope of the claims. All such variations, modifications, and combinations are included herein by the scope of this disclosure and the following claims.

1. A card for selective insertion and withdrawal from a sleeve, the card comprising:
a base panel, the base panel comprising at least a first blister;
a locking panel connected to a first end edge of the base panel along a first hinge;
an additional panel comprising at least a second blister; the additional panel connected to a second edge of the base panel along a second hinge;
a lidding film adhered directly to the base panel and the additional panel and sealing the first and second blisters;
wherein with the card in a flat configuration the lidding film forms a first outward surface and the base panel forms a second, opposed outward surface.

2. The card of claim 1, consisting essentially of a lidding film adhered to a series of panels formed from plastic.

3. The card of claim 1, wherein the series of panels are thermoformed from plastic.

4. The card of claim 1, wherein the second edge is a second end edge of the base panel and is opposite the first end edge of the base panel.

5. The card of claim 1, wherein the second edge is a longitudinal edge of the base panel and is perpendicular to the first end edge of the base panel.

6. The card of claim 1, further comprising a spine panel between the base panel and the additional panel.

7. The card of claim 1, wherein the additional panel is folded along the second hinge and overlaps the base panel with the lidding film in facing relationship.

8. The card of claim 1, wherein the additional panel is folded along the second line until the first and second blisters are in facing relationship.

9. The card of claim 8, wherein the first and second blister are intercalated.

10. The card of claim 9, combined with an open-ended sleeve, wherein the card is received within the sleeve.

11. The card of claim 9, wherein the locking panel is held within the sleeve by the locking panel contacting a lock feature within the sleeve.

12. The card of claim 11, wherein the sleeve comprises a release button which disengages the locking panel from the lock feature.

13. The card of claim 1, wherein the locking panel comprises a stiffening feature.

14. The card of claim 13, wherein the stiffening feature comprises a first debossment.

15. The card of claim 13, wherein the stiffening feature comprises a first embossment.

16. The card of claim 1, wherein the first hinge is formed by a single weakened line.

17. The card of claim 1, wherein the first hinge is formed by a groove line.

18. The card of claim 1 wherein the first hinge is formed by a series of perforations.

19. A card comprising:
a base panel, the base panel comprising at least a first blister;
an additional panel comprising at least a second blister; the additional panel connected to an edge of the base panel along a hinge;
a lidding film adhered directly to the base panel and the additional panel and sealing the first and second blisters;
wherein with the slide card in a flat configuration the lidding film forms a first outward surface and the base panel forms a second, opposed outward surface.
